(19) United States
(12) Patent Application Publication
(10) Pub. No.: US 2009/0058746 A1
(43) Pub. Date: Mar. 5, 2009

(54) EVANESCENT WAVE-COUPLED FREQUENCY SELECTIVE SURFACE

(75) Inventors: Heriberto J. DELGADO, Melbourne, FL (US); Mitchell AHRENDT, Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: HARRIS CORPORATION, Melbourne, FL (US)

(21) Appl. No.: 11/848,280

(22) Filed: Aug. 31, 2007

(51) Int. Cl. H01Q 13/10; H01Q 9/04

(52) U.S. Cl. 343/770; 343/700 MS

(57) ABSTRACT

Multi-layer frequency selective panel includes a group of frequency selective surfaces arranged in a stack. A first frequency selective surface includes a first group of slot elements, and a second frequency selective surface includes a second group of slot elements. The first frequency selective surface and the second frequency selective surface are formed of a conductive metal layer. The first frequency selective surface and the second frequency selective surface are positioned a predetermined distance apart in parallel planes. The second frequency selective surface is disposed in an evanescent field region of the first frequency selective surface.

### BACKGROUND OF THE INVENTION

1. Statement of the Technical Field

The inventive arrangements concern frequency selective surfaces, and more particularly frequency selective surfaces having improved performance, reduced thickness, and reduced weight.

2. Description of the Related Art

A frequency selective surface (FSS) is conventionally designed to either block or pass electromagnetic waves at a selected frequency or frequencies. These types of surfaces are essentially periodic resonance structures that are comprised of a conducting sheet periodically perforated with closely spaced apertures. Alternatively, these structures may be comprised of an array of periodic metallic patches. Many types of FSS element configurations are known, including tripoles, circular rings, Jerusalem crosses, concentric rings, mesh-patch arrays or double squares supported by a dielectric substrate. Depending upon the geometry selected, these can combine features of inductive and capacitive elements and can be used to provide low-pass, high-pass, band-stop, or band-pass responses. U.S. Pat. No. 3,231,892 describes some basic FSS geometries.

Radomes are designed to protect enclosed electromagnetic devices, such as antennas, from environmental conditions such as wind, lightning, solar loading, ice, and snow. An ideal radome is electromagnetically transparent to one or more selected bands of radio frequencies, through a wide range of incident angles. However, in certain applications, it can also be advantageous to provide a radome that is highly frequency selective. Such radomes can help prevent interference from unwanted signals and can be highly reflective to radio frequency energy outside one or more selected passbands. High reflectivity of the radome can be useful in certain applications for reducing radar cross-section (RCS). Accordingly, it can be advantageous to incorporate a pass-band type FSS into a radome.

To obtain improvements in filter band pass characteristics (flat top and fast roll off of transmission response), two or more FSS layers are cascaded behind each other. Generally, each FSS layer is spaced a distance apart equal to a quarter of a wavelength. Still, the transmission curve representing RF energy transmitted through the FSS can change dramatically depending upon the angle of incidence of RF energy. Typical transmission curves for untreated structures are broad in the perpendicular plane and narrow in the parallel plane with respect to the H-plane.

The term “untreated structure” as used herein refers to a multi-layer FSS structure which does not use any dielectric between FSS layers. In such untreated structures, there is free space between each FSS. By choosing an appropriate dielectric thicknesses and layers with the correct dielectric constant, transmission curves can be obtained which have similar bandwidths over various planes of incidence and angles of incidence. In this regard, a quarter wave spacing is conventionally used between each FSS. The dielectric material between each FSS is conventionally selected to help compensate for transmission variations that occur over various angles of incidence.

Still, it is known that the dielectric materials used for this purpose can create additional RF loss. Further, these multiple layer arrangements tend to be relatively thick, and therefore require a relatively large volume. These multi-layer FSS stack-ups also tend to be generally heavy and therefore not well suited to airborne applications. Accordingly, there is a need for low-loss, light weight, and compact arrangements for suitable implementations of radomes with selected passband characteristics.

### SUMMARY OF THE INVENTION

The invention concerns a multi-layer frequency selective panel, which includes a group of frequency selective surfaces arranged in a stack. A first frequency selective surface includes a first group of elements, and a second frequency selective surface includes a second group of elements. The first frequency selective surface and the second frequency selective surface are formed of a conductive metal layer including a plurality of slots, each slot having a predetermined shape. According to one aspect of the invention, the first and second group of elements are identical in size and shape.

The first frequency selective surface and the second frequency selective surface are positioned a predetermined distance apart in parallel planes. The second frequency selective surface is disposed in an evanescent field region of the first frequency selective surface. The evanescent field region as described herein extends less than 0.2 wavelengths from the first frequency selective surface in a direction normal to the parallel planes. Accordingly, the predetermined distance is less than 0.2 wavelengths for a new resonant frequency defined by a geometry and size of the first and second group of elements. The resulting multi-layer frequency selective panel advantageously has at least two resonant frequencies which correspond to two separate passbands. A first resonant frequency and a second resonant frequency of the multi-layer frequency selective panel are determined by (1) a geometry and size of the first and the second group of elements, and (2) the predetermined distance between the first and second frequency selective surface.

The multi-layer frequency selective panel can further include a third frequency selective surface which has a third group of elements, and a fourth frequency selective surface which includes a fourth group of elements. The third and fourth frequency selective surfaces are advantageously positioned parallel to the first frequency selective surface. The third frequency selective surface and the fourth frequency selective surface are positioned a second predetermined distance apart such that the fourth frequency selective surface is disposed in an evanescent field region of the third frequency selective surface. The first, second, third and fourth frequency selective surfaces can have a common resonant frequency.

A third resonant frequency and a fourth resonant frequency of the multi-layer frequency selective panel are determined by (1) a geometry and size of each of the third and the fourth group of elements and (2) the second predetermined distance. For example, the first and third resonant frequency can be equal. Similarly, the second and fourth resonant frequencies can be equal. The second frequency selective surface is spaced a quarter wavelength apart from the third frequency selective surface at a common resonant frequency defined by the first, second, third and fourth group of elements. A dielectric layer can be provided which fills a space between the second frequency selective surface and the third frequency selective surface.

The invention also includes a method for exclusively passing two selected bands of RF energy through a multi-layer frequency selective panel. The method involves positioning a first frequency selective surface and a second frequency selective surface a predetermined distance apart in parallel planes. The method also includes selecting the predetermined distance so that the second frequency selective surface is disposed in an evanescent field region of the first frequency selective surface. A frequency of a first band and a frequency of a second band of the two selected bands of RF energy is selected by (1) choosing a geometry and size of a group of elements used to form the first and second frequency selective surfaces, and (2) by selectively choosing the predetermined distance. The predetermined distance is selected to be less than 0.2 wavelengths for a new resonant frequency defined by a geometry and size of the elements. According to one aspect of the invention, the elements of the first and second frequency selective surfaces can be identical in size and shape. The method includes forming each of the first frequency selective surface and the second frequency selective surface of a conductive metal layer which has a plurality of slots, each having a predetermined shape.

The method also includes positioning a third frequency selective surface and a fourth frequency selective surface a second predetermined distance apart in parallel planes. The fourth frequency selective surface is disposed in an evanescent field region of the third frequency selective surface. The third frequency selective surface is parallel to and a quarter wavelength apart from the second frequency selective surface at the frequency of the first band. The method further includes filling a void between the second and third frequency selective surfaces with a dielectric material.

### BRIEF DESCRIPTION OF THE DRAWINGS

Embodiments will be described with reference to the following drawing figures, in which like numerals represent like items throughout the figures, and in which:

FIG. 1 is a perspective view of a stack of frequency selective surfaces which together form a multi-layer frequency selective panel.

FIG. 2 is an enlarged view of a slot element forming a portion of one layer of the multi-layer frequency selective panel in FIG. 1.

FIG. 3 is a plot which shows a transmission loss for RF signals passing through three different frequency selective structures which is useful for understanding the invention.

FIG. 4 is a cross-sectional view of a stack which includes a plurality of the multi-layer frequency selective panels in FIG. 1.

FIG. 5 is drawing which is useful for understanding various shapes which can be used for slot elements in each layer of the multi-layer frequency selective panel in FIG. 1.

### DETAILED DESCRIPTION OF THE PREFERRED EMBODIMENTS

The invention will now be described more fully hereinafter with reference to accompanying drawings, in which illustrative embodiments of the invention are shown. This invention, may however, be embodied in many different forms and should not be construed as limited to the embodiments set forth herein.

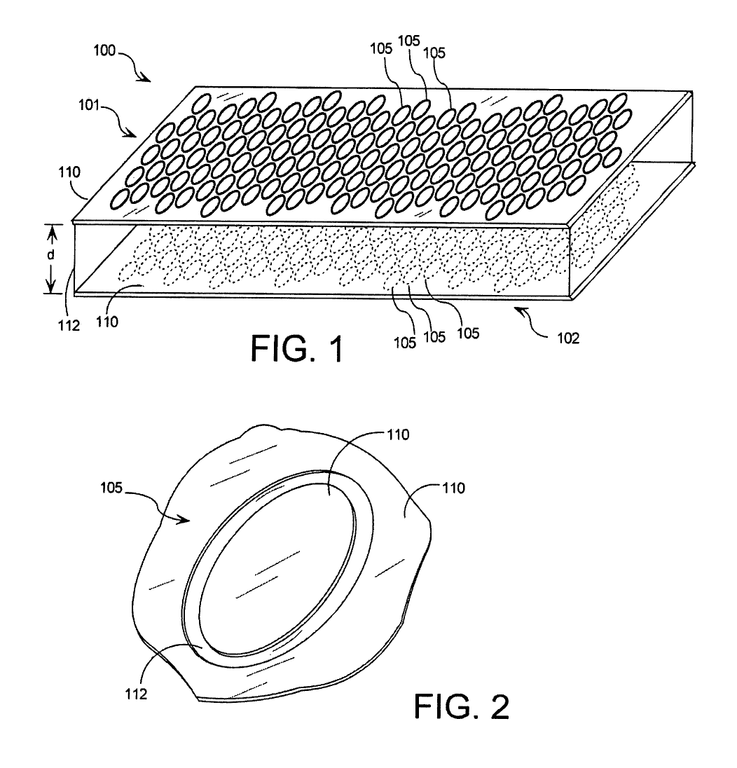

A multi-layer frequency selective panel (MLFSP) 100 is shown in FIG. 1. The MLFSP 100 is formed from a plurality of frequency selective surfaces (FSS) arranged as a plurality of layers in a stack formation. In the embodiment shown in FIG. 1, the MLFSP 100 includes a first FSS 101 comprising a first plurality of elements 105, and a second FSS 102 comprising a second plurality of elements 105. The first FSS 101 and the second FSS 102 are positioned a predetermined distance apart which is identified in FIG. 1 by the letter d. Further, as can be observed in FIG. 1, the first and second FSS 101, 102 are oriented in parallel planes so as to form layers of the MLFSP 100.

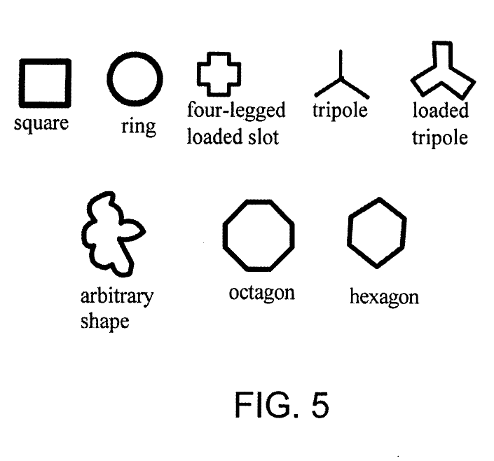

The first and second FSS 101, 102 are each formed from a conductive metal layer 110. For example, copper can be used for this purpose. Referring now to FIG. 2, it can be observed that elements 105 are conventionally formed as slots defined in each conductive metal layer 110. In the embodiment shown, the slots have an elliptical shape. However, it should be understood that any other shape can also be used to form the slots. For example, as shown in FIG. 5, the shape of each slot can be a square, a ring, a four-legged loaded slot, a tripole, a loaded tripole, an octagon, a hexagon, or an arbitrary shape. According to a preferred embodiment, the elements 105 comprising FSS 101 can have the same geometry and size as the elements 105 that comprise the FSS 102. Still, it is possible to form FSS 101 and FSS 102 with elements that are not the same.

In many applications, it is convenient to form the conductive metal layer 110 on a dielectric substrate. In this regard, FIGS. 1 and 2 show that each of the conductive metal layers 110 is disposed on opposing sides of a single dielectric substrate 112. However, the invention is not limited in this regard. In an alternative arrangement, each of the conductive metal layers 110 can be formed on a separate dielectric sheet. If the conductive metal layer 110 is formed on a dielectric substrate, conventional circuit board etching techniques can be used to form each of the elements on opposing sides of the board. According to another alternative embodiment, a dielectric material can be backfilled between the conductive metal layers 110 after the conductive metal layers are positioned some predetermined distance apart.

The dielectric substrate 112 can be any of a variety of known materials that have low loss characteristics at RF frequencies. For example, the dielectric substrate 112 can be a glass micro-fiber reinforced PTFE composite such as RT/duroid, which is commercially available from Rogers Microwave Corporation of Rogers, Conn. Other materials can also be used for this purpose. For example, a polyimide film can also be used. Such polyimide films are available from Sheldahl of Northfield, Minn. Yet another material that can be used for this purpose is a ceramic powder filled, woven micro fiberglass reinforced PTFE composite. Such materials are commercially available from Arlon-MED of Rancho Cucamonga, Calif. Still, the invention is not limited in this regard and other dielectric substrate materials can also be used.

As will be understood by those skilled in the art, a band-pass type FSS 101, 102 can be formed using various types of slots as described herein. When formed in this way, the FSS will pass RF energy at selected frequencies contained in a pass-band, and will reflect RF energy at frequencies above and below the pass-band. For each FSS 101, 102, the frequency of the pass-band will generally be determined by the geometry (shape) and dimensions of the slot that defines each element 105. In this regard it should be noted that the frequency of the pass-band for an FSS will generally correspond to a resonant frequency of the elements 105 that form the FSS. Conventional computer modeling techniques are commonly used to determine the resonant frequency and pass-band frequency of an FSS 101, 102 based on the geometry and dimensions selected for the elements 105.

Referring once again to FIG. 1, the second FSS 102 is advantageously disposed in an evanescent field region of the first FSS 101. In this regard, it should be understood that the evanescent field region of the first FSS 101 is a distance less than or equal to about 0.2 wavelengths from the surface of the FSS 101. The evanescent field region is given by the region where the electric field decays exponentially (and without a phase component) according to the following equation

E=E₀e^{-αz}=E₀e^{-(2π/λ)z}

Where E₀ is the initial value of the electric field, a is a real wave number that models exponential field attenuation and z is a number of wavelengths representing a distance from a surface comprising matter (the FSS surface), and A is a wavelength. The evanescent field region comprises roughly the distance at which the field is attenuated to approximately 0.3 of its initial value. In accordance with the foregoing equation, this distance corresponds to a distance z which is approximately 0.2λ from the planar surface of the FSS 101. Thus, the FSS 102 is positioned less than or equal to 0.2λ from the surface of the FSS 101 when it is within the evanescent field region of FSS 101 as described herein.

The electromagnetic fields in the evanescent region form a near field standing wave. This near file standing wave couples energy from one FSS 101 to the next FSS 102 and thus creates additional resonances. The actual coupled wave can be written as follows:

E=E₀e^{z(-α+jβ)}

From the foregoing equation it can be appreciated that the coupled wave described herein has attenuation mechanisms associated with real wave vector α, and wave propagation mechanisms associated with imaginary wave vector β. In this regard, the arrays of elements 105 formed by FSS 101 and 102 are electromagnetically coupled when positioned as described in an evanescent field region.

In essence, the combination of FSS 101 and 102 comprising MLFSP 100 act as an equivalent, single three-dimensional layer that has at least two resonant frequencies. Significantly, a geometry and size of the elements 105 define a first resonant frequency of the MLFSP 100. The distance d in FIG. 1 defines a second resonant frequency. As the FSS 101 and 102 get closer together, the resonant frequencies move apart from each other. As the FSS 101 and 102 get further apart up to a distance of 0.3 wavelengths, the resonant frequencies move closer to each other. As noted above, these resonant frequencies also define a band-pass frequency.

The first resonant frequency has been described herein as being determined by a geometry and size of the elements that define the FSS 101, 102, whereas the second resonant frequency has been described as being determined by the spacing between the FSS 101 and 102. However, it should be understood that there is a substantial electromagnetic coupling between the FSS 101 and the FSS 102. Consequently, the first resonant frequency due to the slot elements size is also affected to some extent by the resonance associated with the spacing d between the FSS panels 101, 102. This means that any change in the separation will also change the element resonant frequency and vice versa. However, it can be said that the dominant effect of the first resonance is the slot element size and the dominant effect of the second resonance is the separation d between FSS 101 and 102.

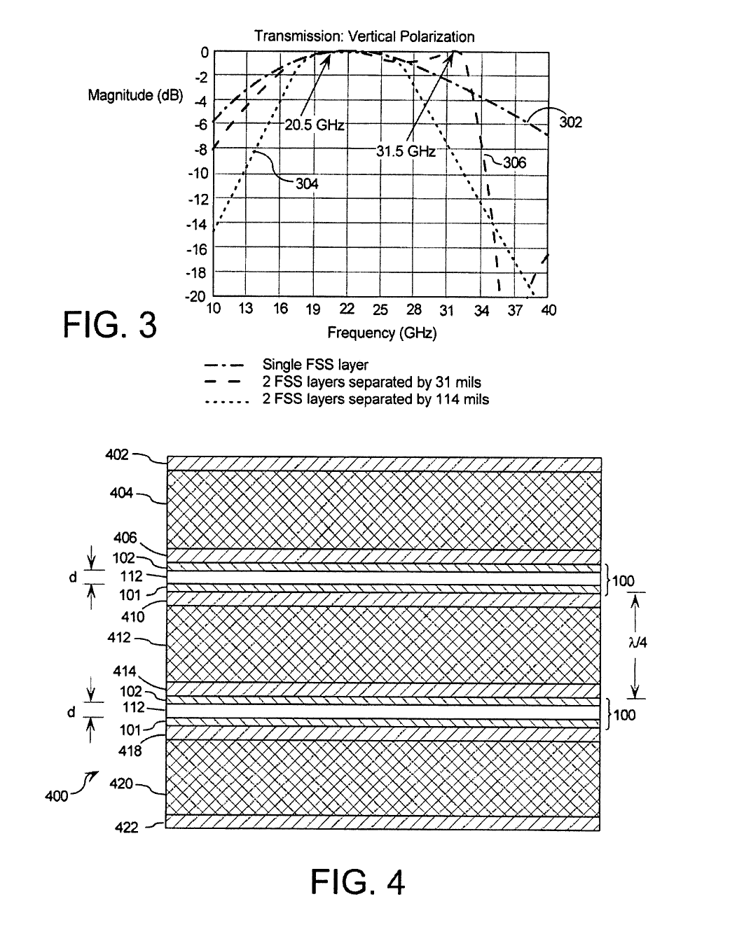

The foregoing concepts can be better understood with reference to FIG. 3 which includes three curves 302, 304, 306 showing a transmission response (vertical polarization, normal incidence) versus frequency for three different structures. The transmission response shows the extent to which RF energy is attenuated at each frequency by each of the different structures. A first one of the curves 302 shows a transmission response for a single FSS layer. An example of such a single FSS layer is a single conductive metal layer 110 as shown in FIG. 1. It can be observed in FIG. 3 that the single FSS layer provides a bandpass filter response with a relatively slow roll-off in frequency response outside of a passband. In contrast, a second curve 304 shows a transmission response for two identical FSS layers which are approximately a quarter wavelength apart (λ/4=114 mils at 26 GHz). This arrangement corresponds to the FSS 101 and 102 spaced apart by a distance d equal to λ/4. It can be observed that the second curve 304 shows a steeper roll-off outside the frequency band as compared to curve 302. This improvement in roll-off is known in the art.

Referring now to curve 306 there is shown a transmission response for two FSS layers 101, 102 that are separated by a distance d=31 mils. This distance of 31 mils corresponds to 0.068λ at 26 GHz. Since this distance is less than 0.2λ, the second FSS 102 is disposed in an evanescent field region of the first FSS 101. Significantly, with the FSS 101, 102 positioned in this way, the curve 306 shows two passbands rather than just one. In particular, a first passband exists at a first resonant frequency of 20.5 GHz and a second passband exists at a second resonant frequency of 31.5 GHz. The first resonance at 20.5 GHz corresponds to element size and geometry; whereas the second resonance at 31.5 GHz corresponds to the particular distance d provided between the FSS 101 and FSS 102. For convenience, in this example no dielectric is used between the FSS 101, 102 for the purpose of evaluating the transmission response.

Curve 306 in FIG. 3 illustrates an important feature of the MLFSP 100 shown in FIG. 1. In particular, the MLFSP 100 permits two closely spaced FSS panels 101, 102 to provide two separate passbands. A frequency of a first one of the passbands is controlled by the size and geometry of the elements 105. A frequency of a second one of the passbands is controlled by the distance d between FSS 101 and FSS 102. Thus, the MLFSP 100 is an extremely compact arrangement of FSS panels that provides two separate passbands.

It may be recalled that conventional FSS panels are commonly cascaded by arranging the conventional FSS panels in a stack. It is known that each FSS panel can be spaced % wavelength apart to obtain improvements in filter band pass characteristics. For example, such an arrangement is known to improve the shape of the passband and to provide faster roll off of transmission response as compared to a single conventional FSS layer. A similar advantage can be obtained with MLFSP 100 by arranging two or more MLFSP 100 panels in a stack, each spaced ¼ wavelength apart. An example of the foregoing arrangement comprising two MLFSP 100 is illustrated in FIG. 4. With regard to the ¼ wavelength spacing, it should be understood that the frequency used for defining the quarter wave spacing is approximately the average of the first resonant frequency and the second resonant frequency at a chosen angle of incidence. Thereafter, the spacing can advantageously be optimized for a desired pass-band performance. In this regard, a design tool is preferably used to determine the separation which gives the best performance over the frequencies of interest and the angle of incidences of interest. For example, there are a variety of well known commercially available software applications which can be used to model the electromagnetic interaction between FSS 101 and FSS 102. Any suitable modeling program can be used to perform these computer optimization processes.

A stacked arrangement as shown in FIG. 4 can further improve the performance of the MLFSP 100. The optimization technique can be similar to that described above with respect to conventional FSS structures. In particular, such an arrangement can improve the shape of the first and second passband and can provide a faster roll off of transmission response for each passband as compared to a single MLFSP 100.

In FIG. 4 MLFSP stack 400 is comprised of two MLFSP 100 which are spaced ¼ wavelength apart. In each MLFSP 100, FSS 101 and FSS 102 are disposed on opposing sides of dielectric layer 112 and separated by a distance d as described above in relation to FIG. 1. Dielectric panel 412 is provided between the two MLFSP 100. The dielectric panel 412 is preferably formed of a dielectric material that has low loss at RF frequencies. According to one embodiment of the invention, the dielectric material comprising dielectric layer 412 can be an epoxy syntactic film formed of SF-06 foam. Such material is commercially available from YLA, Inc. Advanced Composite Materials of Benicia, Calif.

Layers 410 and 414 can be disposed on opposing sides of dielectric panel 412 to improve its mechanical properties. For example, these layers can be formed of a cyanate ester resin such as EX-1515, which is commercially available from TenCate Advanced Composites (formerly Bryte Technologies) of Morgan Hill, Calif.

Dielectric panels 404 and 420 can have a construction that is similar to dielectric panel 412 and can be formed of similar materials. Layers 402, 406, and 418, 422 which are respectively disposed on opposing sides of dielectric panels 404, 420 are likewise preferably formed of materials similar to those used for layers 410, 414.

A relative permittivity of the dielectric material forming panel 412 can be selected to advantageously improve a performance of the MLFSP stack 400. More particularly, the relative permittivity of the dielectric material comprising dielectric layer 412 can be chosen so that transmission curves for MLFSP stack 400 are obtained which have similar bandwidths over various polarizations and angles of incidence. The dielectric material between each FSS is advantageously selected to help compensate for transmission variations that occur over various angles of incidence. Computer modeling can be used to help predict which values of relative permittivity provide best performance.

The quarter wave spacing (λₜ/4) between each FSS layer is calculated by first determining wavelength of the RF energy at the design frequency as follows:

### Where:

$${λ}_{t} = \frac{1}{\sqrt{{ɛ}_{r} {μ}_{r}}} \frac{c}{f}$$

c=speed of light=3×10⁸ meters/second
f=design frequency in Hertz
μᵣ=relative permeability of the dielectric material (typically=1)
εᵣ=relative permittivity of the dielectric material (typically chosen to be a value between 1 and 3 to optimize performance over a predetermined range of scan angles.

From the foregoing descriptions it will be understood that the invention utilizes an evanescent wave coupled field near a metallic slot array. Two or more metallic slot arrays are closely spaced in the evanescent field region to form an MLFSP 100 for achieving a desired frequency response. Groups of these MLFSP 100 can be placed in a MLFSP stack 400 spaced ¼ wavelength apart in a compact radome configuration. The inventive arrangements are especially useful where a low loss, low volume, and light weight radome is desired.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

We claim:

1. A multi-layer frequency selective panel, comprising:
a plurality of frequency selective surfaces arranged in a stack including a first frequency selective surface comprising a first plurality of elements, and a second frequency selective surface comprising a second plurality of elements;
said first frequency selective surface and said second frequency selective surface positioned a predetermined distance apart in parallel planes, and said second frequency selective surface disposed in an evanescent field region of said first frequency selective surface, wherein said multi-layer frequency selective panel has at least two resonant frequencies.

2. The multi-layer frequency selective panel according to claim 1, wherein a first resonant frequency and a second resonant frequency of said multi-layer frequency selective panel are determined by (1) a geometry and size of said first and said second plurality of elements, and (2) said predetermined distance.

3. The multi-layer frequency selective panel according to claim 1, wherein said evanescent field region extends less than 0.2 wavelengths from said first frequency selective surface in a direction normal to said parallel planes.

4. The multi-layer frequency selective panel according to claim 1, where said first frequency selective surface and said second frequency selective surface are formed of a conductive metal layer comprising a plurality of slots, each said slot having a predetermined shape.

5. The multi-layer frequency selective panel according to claim 2, further comprising a third frequency selective surface comprising a third plurality of elements, and a fourth frequency selective surface comprising a fourth plurality of elements, said third frequency selective surface and said fourth frequency selective surface positioned parallel to said first frequency selective surface, said third frequency selective surface and said fourth frequency selective surface positioned a second predetermined distance apart with said fourth frequency selective surface disposed in an evanescent field region of said third frequency selective surface.

6. The multi-layer frequency selective panel according to claim 5, wherein said evanescent field region extends less than 0.2 wavelengths from said first frequency selective surface in a direction normal to said parallel planes.

7. The multi-layer frequency selective panel according to claim 5, wherein said first, second, third and fourth frequency selective surfaces have a common resonant frequency.

8. The multi-layer frequency selective panel according to claim 5, wherein said second frequency selective surface is spaced a quarter wavelength apart from said third frequency selective surface at a common resonant frequency defined by said first, second, third and fourth plurality of elements.

9. The multi-layer frequency selective panel according to claim 8, further comprising a dielectric layer which fills a space between said second frequency selective surface and said third frequency selective surface.

10. A method for exclusively passing two selected bands of RF energy through a multi-layer frequency selective panel, comprising:
positioning a first frequency selective surface and a second frequency selective surface a predetermined distance apart in parallel planes such that said second frequency selective surface is disposed in an evanescent field region of said first frequency selective surface; and
setting a frequency of a first band and a frequency of a second band of said two selected bands of RF energy which are exclusively passed through said multi-layer frequency selective panel by (1) choosing a geometry and size of a plurality of elements comprising said first and second frequency selective surfaces, and (2) by selectively choosing said predetermined distance.

11. The method according to claim 10, further comprising selecting said predetermined distance to be less than 0.2 wavelengths at a resonant frequency defined by a geometry and size of said plurality of elements.

12. The method according to claim 10, further comprising forming each of said first frequency selective surface and said second frequency selective surface of a conductive metal layer comprising a plurality of slots having a predetermined shape.

13. The method according to claim 10, further comprising:
positioning a third frequency selective surface and a fourth frequency selective surface a second predetermined distance apart in parallel planes with said fourth frequency selective surface disposed in an evanescent field region of said third frequency selective surface; and
positioning said third frequency selective surface parallel to and a quarter wavelength apart from said second frequency selective surface at said frequency of said first band.

14. The method according to claim 13, further comprising filling a void between said second and third frequency selective surfaces with a dielectric material.
